(19) United States
(12) Patent Application Publication
(10) Pub. No.: US 2006/0207140 A1
(43) Pub. Date: Sep. 21, 2006

(54) Good Signs

(75) Inventor: Richard Curt Peritz, Coral Springs, FL (US)

Correspondence Address: Richard C. Peritz, 3940 Coral Hills Drive, Coral Springs, FL, 33065, US

(73) Assignee: Mr. Richard C. Peritz, Coral Springs, FL (US)

(21) Appl. No.: 10/906,966

(22) Filed: Mar. 14, 2005

(51) Int. Cl. G09F 13/00

(52) U.S. Cl. 40/553

(57) ABSTRACT

The multi-purpose intelligent Good Sign invention relates to a Multi Purpose improved outdoor lighting and security apparatus for use with illuminated Street signs. It includes Wireless network security video cameras that are mounted within the interior space of the frames of two street signs with names and directions, plus a third top sign illuminated by an array of surface-emitting light-emitting diodes (LEDs) and fluorescent lighting components. The top sign displays messages such as public service, public safety and other messages. The Good Sign will improve public safety by enhancing illumination at street corners while clearly displaying street names, thus enabling both young and elderly to easily find their way. It will reduce accidents and crime, while also providing effective public service information messages on its top sign. Containing wireless network security cameras that can record for hours, these multi-purpose signs will enable law enforcement agencies including Homeland Security to increase public safety. The cameras will enable multiple locations to be monitored from the local law enforcement facility and by officers using laptop computers in their vehicles.

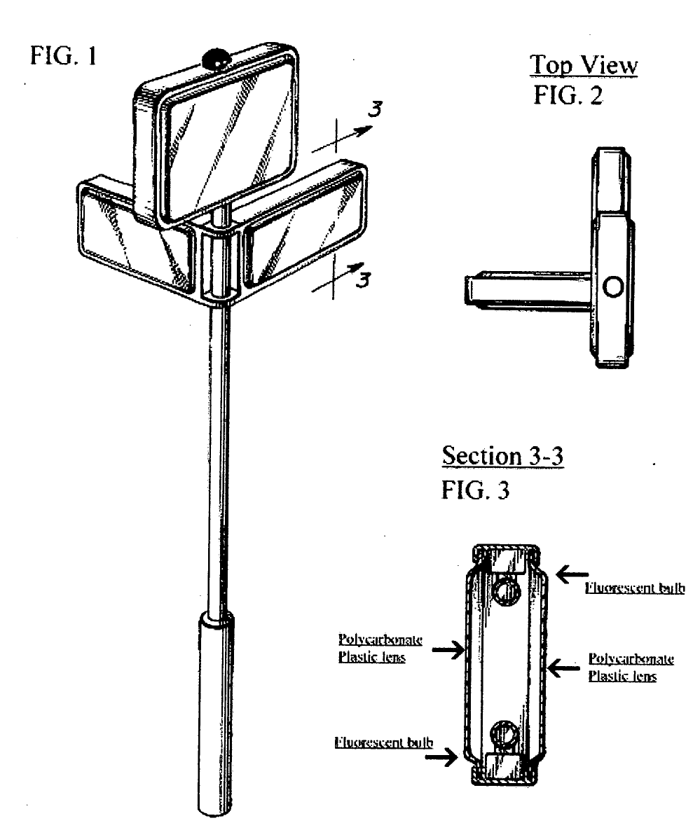

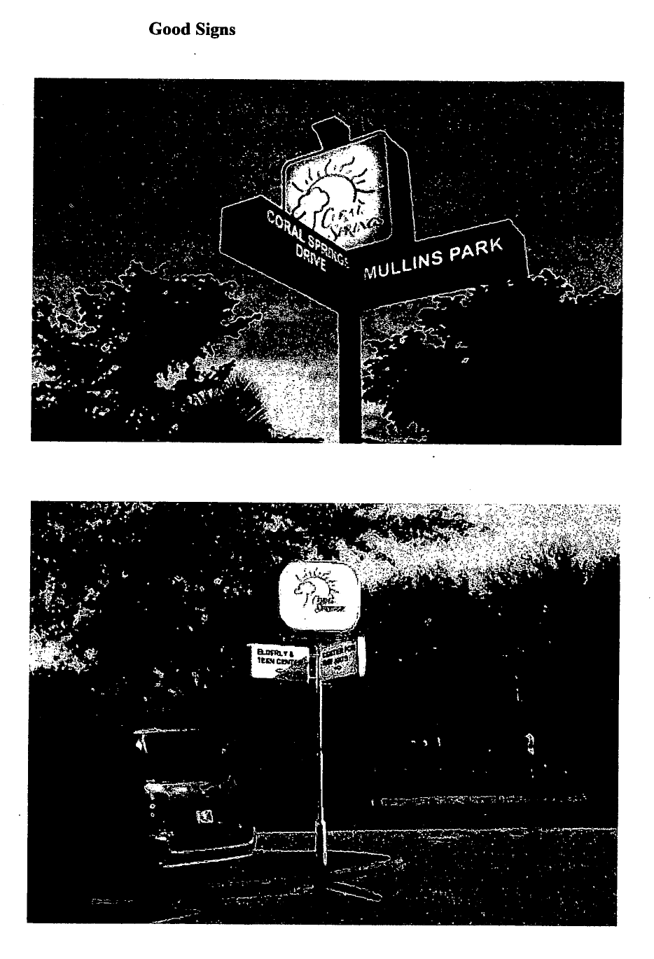

### DESCRIPTION OF INVENTION

Multi-purpose illuminated signs including security cameras and microphones.

What is claimed is:

1. Good Signs are intelligent multi-purpose signs that illuminate street corners and other locations, including wireless network security cameras enhancing public safety and displaying street names, directions and public service messages. The multi-purpose Good Signs provide effective public service information and other messages on its top sign, either utilizing flat translucent lenses and/or electronic LED multi-message sign displays, or other.

2. The apparatus of claim 1, said means for including wireless network security cameras are to enable real-time monitoring of the area the cameras are pointed at, day or night and the cameras can record video and sound for hours. This enables law enforcement, Homeland Security or other agencies to increase public safety. The cameras can be monitored from local police stations and by an officer using a laptop computer in his or her vehicle and the presence of the multi-purpose Good Sign deters crime.

3. The Good Sign enhances public safety and improves visibility of street names or directions and enables both young and elderly to easily find their way, day or night, reduces hesitation at intersections and accidents.
